(19) United States
(12) Patent Application Publication
(10) Pub. No.: US 2005/0180091 A1
(43) Pub. Date: Aug. 18, 2005

(54) High current feedthru device

(75) Inventors: Wilson Hayworth, Blowing Rock, NC (US); Ronald S. Demcko, Raleigh, NC (US)

Correspondence Address: DORITY & MANNING, P.A., POST OFFICE BOX 1449, GREENVILLE, SC, 29602-1449, US

(73) Assignee: AVX Corporation, Myrtle Beach, SC (US)

(21) Appl. No.: 11/034,230

(22) Filed: Jan. 12, 2005

Related U.S. Application Data
(60) Provisional application No. 60/536,066, filed on Jan. 13, 2004.

(51) Int. Cl. H01G 4/228

(52) U.S. Cl. 361/306.3

(57) ABSTRACT

The present disclosure is to a high current multi-layer chip-type feedthru device that may be composed of multiple alternating layers of conductive material and semiconductor material in a fashion to form a feedthru capacitor with transient suppression properties. The disclosed technology provides a feedthru device with significantly improved current handling capability relative to previously known devices having a similar form factor. The improved current handling capability is achieved by a translation of component geometry that results in a substantial decrease in the feedthru capacitor's internal resistance. The conductive layers interleaved among the layers of semiconductive material are characterized as either main signal carrying conductors or transient grounding electrical conductors. Main signal carrying conductors extend along the generally shorter width of the feedthru device, and are characterized by a substantially wide current path. Transient grounding conductors extend in a generally perpendicular fashion to the main signal carrying conductors along the length of the feedthru device. A plurality of solder elements may be plated to the feedthru device for electrically connecting selected of the conductive layers.

### PRIORITY CLAIM

This application claims the benefit of U.S. Provisional Application No. 60/536,066, entitled “HIGH CURRENT FEEDTHRU DEVICE”, filed Jan. 13, 2004, and naming inventors Wilson Hayworth and Ronald S. Demcko, which provisional is incorporated herein by reference for all purposes.

### BACKGROUND OF THE INVENTION

The present subject matter generally concerns a high current chip-type feed-through device that may be utilized for surge protection in a variety of electronic applications. More particularly, the disclosed device is a multi-layer, transient suppressing, feed-through device that is characterized by high current carrying and varistor-like surge suppression capabilities.

A varistor, short for a “voltage-variable resistor,” is a device that has voltage-dependent nonlinear resistance characteristics. Most varistors are composed of a semiconductive material whose resistance is dependent on the voltage applied to the device. A varistor is typically connected in parallel to some electronic device or circuit element in order to protect that device or element from excess voltages. When the electronic device or circuit element is subjected to an increased voltage level, the resistance of the varistor drastically decreases. Thus, in the case of transient voltages, a varistor essentially short circuits the device it is connected to such that potential component damage due to over voltage may be avoided.

Varistors can help provide protection against many types of over voltages, including those caused by lightning, inductive switching, nuclear electromagnetic pulses (NEMP), electrostatic discharge (ESD), or electromagnetic interference (EMI). The performance characteristics of a varistor make it appealing as a protective device in many applications. Such applications include data systems, power supplies, switching equipment, telecommunications systems including RF antennas and RF amplifiers, consumer electronics, automotive systems, and industrial equipment such as control systems, alarm systems, proximity switches, transformers and motors. Varistors may often be particularly beneficial for protecting semiconductor components that are highly sensitive to transient voltages, including silicon diodes and transistors.

Two general types of varistor structures are known in the art, and these correspond to so-called “pressed-pill” type varistors and multi-layer chip-type varistors. The pressed-pill type varistors utilize single layer technology to create generally larger, radial or axial leaded components. These pill varistors typically provide a generally high amount of power protection. An example of a varistor with this pressed-pill type of structure is disclosed in U.S. Pat. No. 5,594,406 (Koyama et al.)

Multi-layer chip varistors are the result of relatively newer technological endeavors, and are typically designed for easy mounting to a substrate. They often are composed of a semiconductive body with internal electrode layers embedded within the device. Peripheral terminations may also be utilized for electrical connection to the internal electrode layers and convenient attachment of the varistor chip to a substrate. Many of such small chip-type devices adapt better than the pill-type devices to the high packaging density of modern integrated circuits and other environments. Examples of protective semiconductor devices characterized by such internal electrodes and end terminations can be found in U.S. Pat. No. 5,976,420 (Nakamura et al.), U.S. Pat. No. 5,119,062 (Nakamura et al.), and U.S. Pat. No. 4,729,058 (Gupta et al.).

Another example of a known multi-layer varistor device is the TransFeed brand transient voltage suppressor, such as that offered for sale by AVX Corporation. This transient voltage suppressor has significant voltage and energy handling capabilities and also EMI/RFI attenuation. Its chip-type design corresponds to a plurality of internal electrode layers embedded in a body of zinc oxide and configured to provide both signal feedthru and transient voltage suppression.

Other signal feedthru and transient voltage suppression arrangements are exemplified by feedthru capacitor devices such as can be found in U.S. Pat. No. 4,935,842 (Carlson et al.) and U.S. Pat. No. 5,531,003 (Seifried et al.).

While various aspects and alternative features are known in the field of feedthru capacitor technology, no one design has emerged that generally integrates all of the ideal features and performance characteristics as discussed herein.

Exemplary background references in addition to those already cited in the specification include the publications by AVX Corporation entitled “Feedthru 0805/1206 Capacitors, W3F/W3F Series” and “Feedthru 0805/1206 Capacitors, W3F/W3F/W3F4 Series” available on AVX Corporations website at the URL address: www.avxcorp.com. The disclosures of all the foregoing United States patents are hereby fully incorporated into this application by reference thereto.

### BRIEF SUMMARY OF THE INVENTION

The present subject matter recognizes and addresses various of the foregoing aspects of feedthru capacitor technology. Thus, broadly speaking, an object of the presently disclosed technology is the provision of improved feedthru capacitor configurations and corresponding performance. More particularly, an object of the disclosed technology is to offer an improved configuration for a multi-layer feedthru chip-type capacitor device.

Another object of some embodiments of the present subject matter is to provide a multi-layer feedthru capacitor that offers effective surge protection and dependable performance for sensing and limiting transient energy pulses in a variety of electronic applications.

Yet another object of some embodiments of the presently disclosed technology is to provide a multi-layer feedthru capacitor that offers a significant increase in current carrying capabilities over that of known multi-layer feedthru capacitor structures.

A still further object of some embodiments of the present subject matter is to provide a multi-layer feedthru capacitor that offers a significant increase in current carrying capabilities while at the same time providing such increased capabilities in a device utilizing the same form factor, or overall component size, as previous, less robust devices.

Another object of some embodiments of the present technology is to provide a multi-layer feedthru device that provides dual frequency filtering by adjusting selected electrically conductive elements to predetermined lengths.

Yet another object of some embodiments of the presently disclosed technology is to provide various process steps and methodology associated with the formation of exemplary multi-layer feedthru capacitor configurations and embodiments as discussed herein.

Additional objects and advantages of the present subject matter are set forth in, or will be apparent to those of ordinary skill in the art from, the detailed description herein. Also, it should be further appreciated by those of ordinary skill in the art that modifications and variations to the specifically illustrated, referenced, and discussed features and steps hereof may be practiced in various embodiments and uses of this subject matter without departing from the spirit and scope thereof, by virtue of present reference thereto. Such variations may include, but are not limited to, substitution of equivalent means and features, materials, or steps for those shown, referenced, or discussed, and the functional, operational, or positional reversal of various parts, features, steps, or the like.

Still further, it is to be understood that different embodiments, as well as different presently preferred embodiments, of this subject matter may include various combinations or configurations of presently disclosed features, steps, or elements, or their equivalents (including combinations of features or steps or configurations thereof not expressly shown in the figures or stated in the detailed description).

A first exemplary embodiment of the present subject matter corresponds to a multi-layer feedthru device including a body having a width dimension generally shorter than a length dimension thereof, and having multiple alternating layers of conductive and semiconductive material. Selected of the layers of conductive material correspond to main signal carrying conductors that extend along the generally shorter width of the device body, while other layers of conductive material correspond to transient grounding electrical conductors that extend along the length of the device body in a generally perpendicular fashion to the main signal carrying conductors. The main signal carrying conductors have a generally wide current path such that the resulting internal equivalent series resistance of the feedthru device is relatively decreased while the current handling capability of the feedthru device is relatively increased.

In some more particular exemplary embodiments of the above multi-layer feedthru device, each transient grounding electrical conductor comprises paired portions having respective first and second predetermined lengths. The first and second predetermined lengths may be substantially equal in some embodiments or may be substantially not equal in other embodiments to provide dual frequency filtering at two different respective predetermined frequencies. The length of the multi-layer feedthru device may be about twice as long as the generally shorter width of the device, and relatively wider current paths of the main signal carrying conductors may have dimensions that are greater than the generally shorter width of the device. The multi-layer feedthru device may also include metallic elements, at least one of which is attached to and electrically connecting selected of the main signal carrying conductors, and at least one of which is attached to and electrically connecting selected of the transient grounding electrical conductors.

Another exemplary embodiment of the present subject matter corresponds to a multi-layer feedthru device including a body of semiconductive material, a plurality of generally planar first conductive layers disposed within the body of semiconductive material and configured for propagation of electrical signals therethrough, and a plurality of generally planar second conductive layers also disposed within the body of semiconductive material and configured for connection thereof to an electrical ground. The body of semiconductive material has a first pair of opposing sides spaced from one another by a first dimension and a second pair of opposing sides spaced from one another by a second dimension. Each of the first conductive layers extends along the first dimension between the first pair of opposing sides, and each first conductive layer is also characterized by a third dimension. Each second conductive layer extends along the second dimension between the second pair of opposing sides. In the above exemplary configuration, the third dimension is longer than the first dimension, and the second dimension is longer than the third dimension.

In more particular embodiments of the above-referenced feedthru device, the second dimension may be about twice as long as the first dimension and the third dimension may have a value equal to about seventy-five percent of the second dimension. The body of semiconductive material may comprise a metal oxide such as zinc oxide. The device may have an increased current rating, such as one on the order of between about five and about ten Amperes. Electrical terminations may also be provided on respective sides of the device for connecting first conductive layers together and separately connecting second conductive layers together.

Yet another exemplary embodiment of the present subject matter corresponds to a multi-layer feedthru device including a plurality of semiconductive layers, a plurality of conductive ground layers and a plurality of conductive signal layers alternately interleaved among the plurality of semiconductive layers so as to form a stacked assembly. The stacked assembly has respective topmost and bottommost layers (which correspond to semiconductive layers in some embodiments), a pair of first opposing side surfaces separated from one another by a first distance, and a pair of second opposing side surfaces separated from one another by a second distance. The second distance is greater than the first distance. Each conductive signal layer extends to and is exposed along at least one side surface of the pair of first opposing side surfaces, while each conductive ground layer extends to and is exposed along at least one side surface of the pair of second opposing side surfaces.

In more particular exemplary embodiments of the above multi-layer feedthru device, the second distance may be about twice as long as the first distance. In other embodiments, the portion of each conductive signal layer exposed along at least one side surface of the pair of first opposing side surfaces is characterized by a third distance that is generally greater than the first distance, and in some embodiments has a value equal to about seventy-five percent of the second distance. The plurality of semiconductive layers may comprise zinc oxide in some embodiments, and the device may have a current rating of between about five and about ten Amperes in some embodiments. An exemplary multi-layer feedthru device may also include at least one first electrical termination provided on each side surface of the pair of first opposing side surfaces and connected to each of the plurality of conductive signal layers, as well as at least one second electrical termination provided on each side surface of the pair of second opposing side surfaces and connected to each of the plurality of conductive ground layers.

In still further more particular exemplary embodiments, each conductive ground layer includes respective first and second conductive portions, wherein each first conductive portion of each conductive ground layer extends to and is exposed along a selected one of the pair of second opposing side surfaces and is characterized by a distance L1, and wherein each second conductive portion of each conductive ground layer extends to and is exposed along the other of the pair of second opposing side surfaces and is characterized by a distance L2. Distances L1 and L2 may be substantially equal in some embodiments or may be different values so as to effect signal filtering at two different predetermined frequencies in other embodiments. In such embodiments, at least one first electrical termination may be provided on each side surface of the pair of first opposing side surfaces and connected to each of the plurality of conductive signal layers, while at least one second electrical termination is provided on a selected one of the pair of second opposing side surfaces and connected to each of the first conductive portions of each conductive ground layer and at least one additional second electrical termination is provided on the other one of the pair of opposing second side surfaces and connected to each of the second conductive portions of each conductive ground layer.

A still further exemplary embodiment of the present subject matter corresponds to a surface-mounted feedthru device including a printed circuit board, a feedthru device, and first, second, third and fourth electrical connections. The printed circuit board has at least one signal line connection thereon and at least one ground plane connection thereon. The feedthru device more particularly includes a body of semiconductive material, a plurality of generally planar conductive signal layers disposed within the body of semiconductive material, and a plurality of generally planar conductive ground layers disposed within the body of semiconductive material. The body of semiconductive material has a first pair of opposing sides spaced from one another by a first dimension and a second pair of opposing sides spaced from one another by a second dimension, wherein the second dimension is greater than the first dimension. Each generally planar conductive signal layer extends to and is exposed along at least one of the first pair of opposing sides, while each generally planar conductive ground layer extends to and is exposed along at least one of the second pair of opposing sides. The first and second electrical connections connect the generally planar conductive signal layers to the at least one signal line connection on the printed circuit board, while the third and fourth electrical connections connect the generally planar conductive ground layers to the at least one ground plane connection on the printed circuit board.

In accordance with more particular exemplary embodiments of the above exemplary surface-mounted feedthru device, the first, second, third and fourth electrical connections may comprise solder connections and/or terminations provided on selected sides of the body of semiconductive material. The second dimension of the body of the feedthru device may be about twice as long as the first dimension. The portion of each generally planar conductive signal layer exposed along at least one of the first pair of opposing sides may be characterized by a third dimension greater than the first dimension. Each generally planar conductive ground layer may include respective first and second conductive portions, wherein each first conductive portion of each generally planar conductive ground layer extends to and is exposed along a selected one of the second pair of opposing sides and is characterized by a distance L1, and wherein each second conductive portion of each generally planar conductive ground layer extends to and is exposed along the other of the second pair of opposing sides and is characterized by a distance L2. Distances L1 and L2 may be substantially equal in some embodiments or may be different values so as to effect signal filtering at two different predetermined frequencies in other embodiments.

Such exemplary embodiments and others in accordance with the disclosed subject matter may preferably be created using various aspects of thin-film technology. For example, certain elements of the subject multi-layer feedthru capacitor may be applied in accordance with plating or etching methods or aspects of photolithography as should be well known by one of ordinary skill in the art of thin film components and related techniques.

Additional embodiments of the subject technology, not necessarily expressed in this summarized section, may include and incorporate various combinations of aspects of features, parts, or steps referenced in the summarized objectives above, and/or features, parts, or steps as otherwise discussed in this application.

The present subject matter equally concerns various exemplary corresponding methodologies for practice and manufacture of all of the herein referenced multi-layer feedthru capacitor configurations and related technology.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 displays a generally top view of an exemplary embodiment of the multi-layer feedthru capacitor in accordance with the present technology;

FIG. 2 displays a generally side view of an exemplary embodiment of the multi-layer feedthru capacitor in accordance with the present technology;

FIG. 3 provides a top partially cut away view of a first multi-layer feedthru capacitor embodiment in accordance with the present technology;

FIG. 4 provides a partially cut away cross-sectional view of a first exemplary multi-layer feedthru capacitor embodiment in accordance with the present technology, including exemplary conductive layer portions as displayed in FIG. 3;

FIG. 5 provides a top partially cut away view of a second multi-layer feedthru capacitor embodiment in accordance with the present technology;

FIG. 6 provides a partially cut away cross-sectional view of a second exemplary multi-layer feedthru capacitor embodiment in accordance with the present technology, including exemplary conductive layer portions as displayed in FIG. 5;

FIG. 7 provides a top partially cut away view of a multi-layer feedthru capacitor in accordance with previously known technology;

FIG. 8 provides a partially cut away cross-sectional view of a multi-layer feedthru capacitor in accordance with previously known technology; and

FIG. 9 provides a perspective representation of the multi-layer feedthru capacitor of the present technology secured to a printed circuit board.

Repeat use of reference characters throughout the present specification and appended drawings is intended to represent same or analogous features or elements of the present subject matter.

### DETAILED DESCRIPTION OF THE DRAWINGS

As referenced in the Brief Summary of the Invention section, supra, the present subject matter is directed towards improved multi-layer feedthru capacitor configurations and performance characteristics thereof.

More particularly, one example of the disclosed multi-layer feedthru capacitor offers a significantly higher current carrying capacity than previously available and does so using substantially the same form factor as previously employed with less robust, but generally similar, devices.

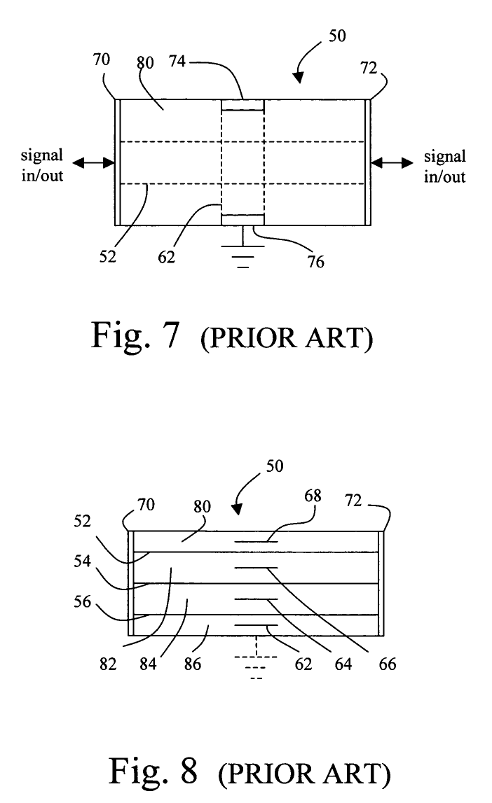

A known arrangement of a multi-layer feedthru capacitor will be discussed with reference to FIGS. 7 and 8. With reference to FIGS. 7 and 8, it will be observed that there has been illustrated a known multi-layer feedthru capacitor generally like that described in the previously mentioned AVX Corporation publications. The device illustrated may be, as an example, housed in a 1206 or 0805 case size and may consist of a number of layers of conductive material sandwiched between layers of semiconductive material. The “0805” and “1206” designations are standard EIA (Electronic Industries Association) designations for devices having dimensions of approximately 0.08 by 0.05 inches and 0.12 by 0.06 inches, respectively. It should be appreciated that the figures discussed herein are not necessarily drawn to scale, though representation of at least general relationships is intended. Also, it should be appreciated that selected elements of each figure may not be represented in proportion to other elements in that figure. In addition, materials that are listed as exemplary substances for forming certain elements of the embodiments as discussed herein are merely presented as examples, and should in no way limit the scope of the disclosure as to specific composition of particular varistor embodiments as may be practiced in accordance with the present subject matter. It should be appreciated that as newly improved materials are designed and/or created, incorporation of such substances with the technology disclosed herein will be anticipated.

Referring now to the drawings, FIGS. 7 and 8 relate to a known exemplary embodiment of a multi-layer feedthru capacitor device incorporating transient suppression features. Such exemplary multi-layer feedthru capacitor device 50 typically corresponds to a rectangular shaped multi-layer configuration of layers 80, 82, 84, 86 of semiconductive material sandwiched between multiple layers 52, 54, 56 and 62, 64, 66, 68 of electrically conductive material. Electrically conductive layers 52, 54, 56 are connected together at each end of feedthru device 50 by plated terminals 70, 72 and operate, in parallel, as the main signal path for the feedthru device. Electrically conductive layers 62, 64, 66, 68 are similarly connected together by plated terminals 74, 76, which terminals may normally be connected to ground or earth reference. Such terminals 74, 76 can alternatively be connected to a differential ground plane relative to terminals 70 and 72 in the case of floating electrode designs. As may be seen from FIGS. 7 and 8, the various electrically conductive layers are interleaved with layers of semiconductive material in such a fashion as to form equivalent capacitors between the signal transporting electrically conductive layers 52, 54, 56 and the normally grounded electrically conductive layers 62, 64, 66, 68. Additionally, the semiconductive material may be composed of a material based on zinc oxide and, therefore, operates as a varistor to shunt voltage transients to ground by way of plated terminals 74, 76. In this way, signal input/output lines and other electrical components connected thereto may be protected from damage caused by transients applied to or induced in any signal line connected to the feedthru device.

Further with respect to the previously known device depicted in FIGS. 7 and 8, it will be observed that the main signal carrying electrical conductors 52, 54, 56 extend along the length of the feedthru capacitor device, i.e., from left to right as shown in FIGS. 7 and 8 while the transient grounding electrical conductors 62, 64, 66, 68 extend in a perpendicular direction to the electrical conductors 52, 54, 56. The result of such an arrangement is that the electrical conductors 52, 54, 56 are relatively long and narrow since they extend along the longer dimension of the feedthru capacitor device, thus resulting in a relatively high equivalent series resistance for the signal path. This relatively high resistance for the signal path effectively limits the amount of current that may be safely carried by the conductors. In an exemplary embodiment of the prior known feedthru capacitor device, the maximum current was limited to about 300 mA.

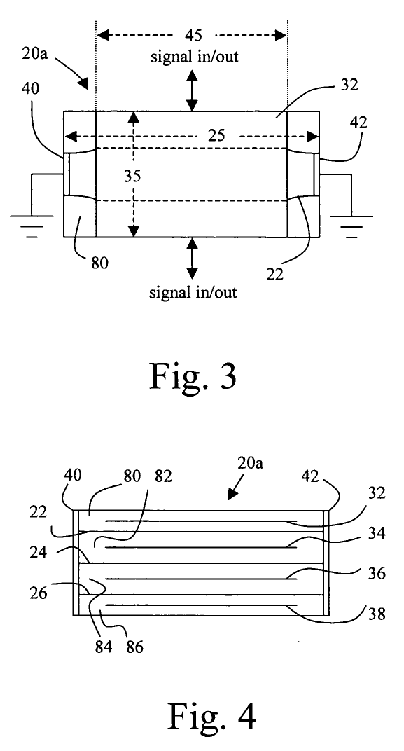

A first exemplary embodiment of the present technology will now be described with reference to FIGS. 3 and 4. With reference to FIGS. 3 and 4, a comparison of the multi-layer feedthru capacitive device 20a in accordance with the present technology to that of the previously known device 50 illustrated in FIGS. 7 and 8 reveals a device having a similar form factor. The multi-layer feedthru capacitive device 20a in accordance with one embodiment of the present technology includes electrical conductive layers 22, 24, 26 extending along the length of the feedthru capacitive device, i.e. from left to right in FIGS. 3 and 4, as well as electrically conductive layers 32, 34, 36, 38 extending along the width of the multi-layer feedthru capacitive device, i.e., from top to bottom in FIG. 3. In addition, the multi-layer feedthru capacitive device 20a as illustrated in FIGS. 3 and 4 also includes semiconductive layers 80, 82, 84, 86 of similar construction and operational characteristics to corresponding layers of the previously known technology illustrated in FIGS. 7 and 8. As in the previously known technology, these semiconductive layers 80, 82, 84, 86 provide a transient voltage suppression capability for the multi-layer feedthru capacitive device and may be composed of a metal oxide such as a zinc oxide based material or other suitable voltage dependent materials.

A significant difference between the present technology and that previously known resides in the substantial reversal of geometry between the present and previous technologies. As is evident from a comparison of FIGS. 3 and 4 with FIGS. 7 and 8, the generally planar electrically conductive elements 32, 34, 36, 38 forming the principle signal path for the present technology (denoted as “signal in/out,” as show in FIGS. 3 and 7 and referred to herein as conductive signal layers or first conductive layers configured for propagation of electrical signals therethrough) are much shorter and, at the same time, much wider than the similarly functioning elements 52, 54, 56 of the previously known technology illustrated in FIG. 7. Such conductive signal layers 32, 34, 36 and 38 generally extend along a first dimension 35 between a first pair of opposing sides of the feedthru device 20a. Generally planar conductive elements 22, 24 and 26 form the ground path for the present technology, and are illustrated as such by their schematic connection to ground in FIG. 3. Such conductive elements 22, 24 and 26 are referred to herein as conductive ground layers or second conductive layers configured for connection thereof to an electrical ground. Such conductive ground layers 22, 24 and 26 generally extend along a second dimension 25 between a second pair of opposing sides of the feedthru device 20a.

With further reference to the exemplary feedthru device embodiment 20a, in an exemplary 1206 form factor, the second dimension 25 is about twice as long as the first dimension 35. As such, the equivalent series resistance is reduced by 50% due to reducing the current path through the chip from 120 mils to 60 mils. Furthermore, each conductive signal layer 32, 34, 36 and 38 has a generally wide current path characterized by a third dimension 45. The equivalent series resistance is reduced again due to the fact that this current path has increased in width from 45 mils to 90 mils (i.e., the third dimension 45 is greater than the first dimension 35 and about seventy-five percent (75%) of the second dimension 25). The combination of these reductions provides an overall 75% reduction in internal resistance and a consequent increase in the current handling capability of the device. As previously noted, prior similar devices were rated at 300 mA while the present technology enables current ratings of 5 to 10 amperes or more in a device using the same form factor as the previously known technology. An additional advantage is obtained by this construction in that the much wider electrode tab resulting from the much wider electrically conductive electrode element provides a better termination to electrode connection when securing the devices to circuit boards and generally within other electronic devices.

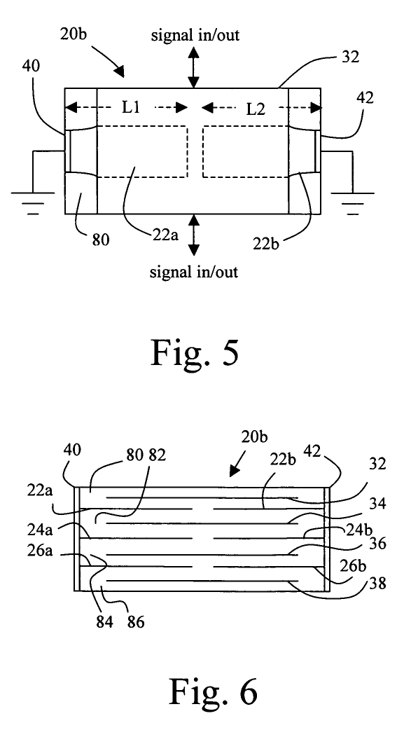

A second exemplary embodiment of the present subject matter is now presented with respect to FIGS. 5 and 6. Many aspects of such second exemplary embodiment of the present technology are similar to those of the first exemplary multi-layer feedthru device as illustrated in FIGS. 3 and 4. Like reference numerals are utilized to depict such similar aspects, and particular features of such aspects as discussed with reference to FIGS. 3 and 4 equally apply to the exemplary embodiment of FIGS. 5 and 6.

The main difference between the first exemplary feedthru device embodiment 20a (as depicted in FIGS. 3 and 4) and the second exemplary feedthru device embodiment 20b of FIGS. 5 and 6 is that the electrical conductive layers 22, 24 and 26 (i.e., the conductive ground layers) of feedthru device 20a are replaced in feedthru device 20b by respective paired conductive layer portions 22a/22b, 24a/24b and 26a/26b. In other words, each conductive ground layer 22, 24, 26 now includes a first conductive ground portion 22a, 24a or 26a and a second conductive ground portion 22b, 24b or 26b. By providing electrically conductive elements that are cut to different lengths relative to the amount of area they overlap respective electrically conductive elements 32, 34, 36 and 38, predetermined resonant frequencies of feedthru device 20b can be effected. More particularly, where feedthru device 20a is designed to typically provide filtering functionality at a single resonant point, dual frequency filtering can be provided by the feedthru device 20b of FIGS. 5 and 6. For example, first conductive ground portions 22a, 24a and 26a could all be a predetermined shorter distance L1 than the lengths L2 of respective second conductive ground portions 22b, 24b and 26b, or vice versa. The respective longer and shorter lengths of paired conductive ground portions 22a/22b, 24a/24b and 26a/26c can be designed for operation at different respective predetermined frequencies. Alternatively, paired conductive ground portions 22a/22b, 24a/24b and 26a/26c may in some embodiments be about the same length (i.e., L1≅L2) to provide a symmetrical T-filter type functionality.

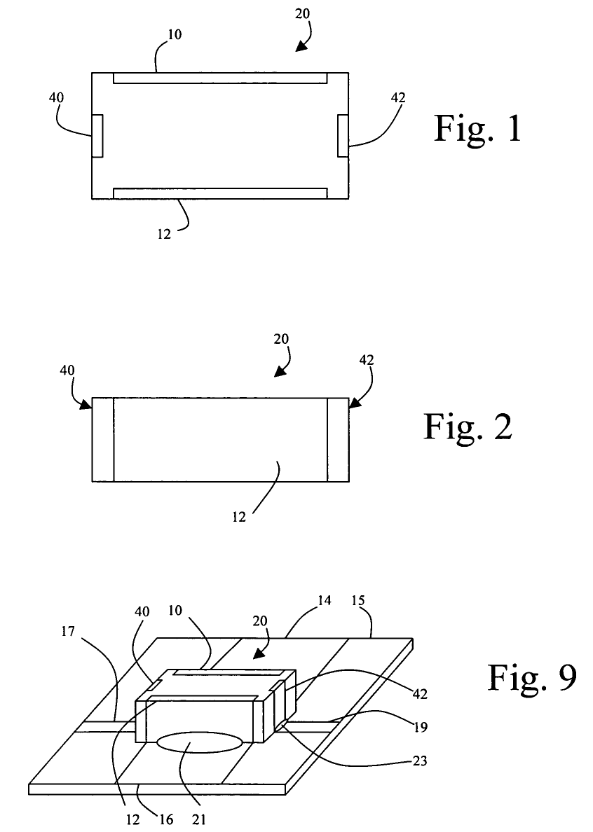

FIG. 1 provides a general representation of the final form of a multi-layer capacitive feedthru device 20 of the present technology. General reference to feedthru device 20 is intended to encompass either of the exemplary embodiments 20a or 20b as previously described. Principle signal input/output terminals 10, 12 are provided by plating termination of the signal carrying electrical conductors 32, 34, 36, 38 as they may be exposed at the longer side surfaces of the body of semiconductive material generally forming the feedthru device. At least one electrical termination is provided on each of these generally longer side surfaces for connecting to each of the conductive signal layers 32, 34, 36 and 38. Grounding terminals 40, 42 are provided by plating termination of the electrically conductive layers 22, 24, 26 (or paired conductive layer portions 22a/22b, 24a/24b, 26a/26b) as they are exposed at the shorter side surfaces of the body of semiconductive material generally forming the feedthru device. At least one electrical termination is provided on each of these generally shorter side surfaces for connecting to the conductive ground layers 22, 24 and 26. When conductive ground layers 22, 24 and 26 include paired conductive ground portions 22a/22b, 24a/24b and 26a/26b, as illustrated in FIGS. 5 and 6, one of the electrical terminations 40, 42 connects to each of the first conductive ground portions 22a, 24a and 26a while the other of the electrical terminations 40, 42 connects to each of the second conductive ground portions 22b, 24b and 26b.

FIG. 9 represents a perspective view of the multi-layer feedthru capacitive device 20 of the present technology mounted to a printed circuit board 15 by way of solder connections 21, 23 or other similarly effective electrical connections. As illustrated in FIG. 9, printed circuit board 15 includes at least one signal line connection (embodied by signal lines 14, 16) and at least one ground plane connection (embodied by ground plane connections 17 and/or 19). First and second electrical connections are provided from each conductive signal layer within feedthru device 20 to signal lines 14, 16 by a selective combination of terminations 10, 12 and electrical/solder connections 21 (only one of which is visible in FIG. 9). Third and fourth electrical connections are provided from each conductive ground layer within feedthru device 20 to ground plane connections 17, 19 by a selective combination of terminations 40, 42 and electrical/solder connections 23 (only one of which is visible in FIG. 9).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A multi-layer feedthru device, comprising:
a body of semiconductive material having a first pair of opposing sides spaced from one another by a first dimension and a second pair of opposing sides spaced from one another by a second dimension;
a plurality of generally planar first conductive layers disposed within said body of semiconductive material and configured for propagation of electrical signals therethrough, wherein each of said first conductive layers extends along said first dimension between said first pair of opposing sides, and wherein each first conductive layer is also characterized by a third dimension; and
a plurality of generally planar second conductive layers disposed within said body of semiconductive material and configured for connection thereof to an electrical ground, wherein each of said second conductive layers extends along said second dimension between said second pair of opposing sides; and
wherein said third dimension is longer than said first dimension, and wherein said second dimension is longer than said third dimension.

2. The multi-layer feedthru device of claim 1, wherein said second dimension is about twice as long as said first dimension.

3. The multi-layer feedthru device of claim 1, wherein said third dimension has a value equal to about seventy-five percent of said second dimension.

4. The multi-layer feedthru device of claim 1, wherein said body of semiconductive material comprises a metal oxide.

5. The multi-layer feedthru device of claim 1, wherein said body of semiconductive material comprises zinc oxide.

6. The multi-layer feedthru device of claim 1, wherein said device has a current rating between about five and about ten Amperes.

7. The multi-layer feedthru device of claim 1, further comprising:
at least one first electrical termination provided on each side of said first pair of opposing sides and electrically connected to each said first conductive layer; and
at least one second electrical termination provided on each side of said second pair of opposing sides and electrically connected to each of said second conductive layers.

8. A multi-layer feedthru device, comprising:
a plurality of semiconductive layers; and
a plurality of conductive ground layers and a plurality of conductive signal layers alternately interleaved among said plurality of semiconductive layers so as to form a stacked assembly;
wherein said stacked assembly has respective topmost and bottommost layers, a pair of first opposing side surfaces separated from one another by a first distance, and a pair of second opposing side surfaces separated from one another by a second distance, and wherein said second distance is greater than said first distance;
wherein each of said conductive signal layers extends to and is exposed along at least one side surface of said pair of first opposing side surfaces; and
wherein each of said conductive ground layers extends to and is exposed along at least one side surface of said pair of second opposing side surfaces.

9. The multi-layer feedthru device of claim 8, wherein said second distance is about twice as long as said first distance.

10. The multi-layer feedthru device of claim 8, wherein the portion of each conductive signal layer exposed along at least one side surface of said pair of first opposing side surfaces is characterized by a third distance, and wherein said third distance is greater than said first distance.

11. The multi-layer feedthru device of claim 10, wherein said third distance has a value equal to about seventy-five percent of said second distance.

12. The multi-layer feedthru device of claim 8, wherein said plurality of semiconductive layers comprise zinc oxide.

13. The multi-layer feedthru device of claim 8, wherein said device has a current rating between about five and about ten Amperes.

14. The multi-layer feedthru device of claim 8, wherein said topmost and bottommost layers of said stacked assembly comprise semiconductive layers.

15. The multi-layer feedthru device of claim 8, further comprising:
at least one first electrical termination provided on each side surface of said pair of first opposing side surfaces and connected to each of said plurality of conductive signal layers; and
at least one second electrical termination provided on each side surface of said pair of second opposing side surfaces and connected to each of said plurality of conductive ground layers.

16. The multi-layer feedthru device of claim 8, wherein each said conductive ground layer comprises respective first and second conductive portions, wherein each first conductive portion of said each conductive ground layer extends to and is exposed along a selected one of said pair of second opposing side surfaces, and wherein each second conductive portion of said each conductive ground layer extends to and is exposed along the other of said pair of second opposing side surfaces.

17. The multi-layer feedthru device of claim 16, wherein each said first conductive portion of said each conductive ground layer is characterized by a distance L1 measured between said pair of second opposing side surfaces, and wherein each said second conductive portion of said each conductive ground layer is characterized by a distance L2 measured between said pair of second opposing side surfaces, and wherein distance L1 is substantially equal to distance L2.

18. The multi-layer feedthru device of claim 16, wherein each said first conductive portion of said each conductive ground layer is characterized by a distance L1 measured between said pair of second opposing side surfaces, and wherein each said second conductive portion of said each conductive ground layer is characterized by a distance L2 measured between said pair of second opposing side surfaces, and wherein distances L1 and L2 are different values so as to effect signal filtering at two different predetermined frequencies.

19. The multi-layer feedthru device of claim 16, wherein said second distance is about twice as long as said first distance.

20. The multi-layer feedthru device of claim 16, wherein the portion of each conductive signal layer exposed along at least one side surface of said pair of first opposing side surfaces is characterized by a third distance, and wherein said third distance is greater than said first distance.

21. The multi-layer feedthru device of claim 20, wherein said third distance has a value equal to about seventy-five percent of said second distance.

22. The multi-layer feedthru device of claim 16, wherein said plurality of semiconductive layers comprise zinc oxide.

23. The multi-layer feedthru device of claim 16, wherein said device has a current rating between about five and about ten Amperes.

24. The multi-layer feedthru device of claim 16, wherein said topmost and bottommost layers of said stacked assembly comprise semiconductive layers.

25. The multi-layer feedthru device of claim 16, further comprising:
at least one first electrical termination provided on each side surface of said pair of first opposing side surfaces and connected to each of said plurality of conductive signal layers; and
at least one second electrical termination provided on a selected one of said pair of second opposing side surfaces and connected to each of said first conductive portions of said each conductive ground layer, and at least one additional second electrical termination provided on the other one of said pair of second opposing side surfaces and connected to each of said second conductive portions of said each conductive ground layer.

26. A surface-mounted feedthru device, comprising:
a printed circuit board having at least one signal line connection and at least one ground plane connection;
a feedthru device, comprising:
a body of semiconductive material having a first pair of opposing sides spaced from one another by a first dimension, and a second pair of opposing sides spaced from one another by a second dimension, wherein said second dimension is greater than said first dimension;
a plurality of generally planar conductive signal layers disposed within said body of semiconductive material, whererin each generally planar conductive signal layer extends to and is exposed along at least one of said first pair of opposing sides; and
a plurality of generally planar conductive ground layers disposed within said body of semiconductive material, wherein each generally planar conductive ground layer extends to and is exposed along at least one of said second pair of opposing sides; and
first and second electrical connections from said plurality of generally planar conductive signal layers to the at least one signal line connection on said printed circuit board; and
third and fourth electrical connections from said plurality of generally planar conductive ground layers to the at least one ground plane connection on said printed circuit board.

27. The surface-mounted feedthru device of claim 26, wherein selected of said first, second, third and fourth electrical connections comprise solder connections.

28. The surface-mounted feedthru device of claim 27, wherein selected of said first, second, third and fourth electrical connections further comprise terminations provided on selected sides of said body of semiconductive material.

29. The surface-mounted feedthru device of claim 26, wherein said second dimension is about twice as long as said first dimension.

30. The surface-mounted feedthru device of claim 26, wherein the portion of each generally planar conductive signal layer exposed along at least one of said first pair of opposing sides is characterized by a third dimension, and wherein said third dimension is greater than said first dimension.

31. The surface-mounted feedthru device of claim 26, wherein each said generally planar conductive ground layer comprises first and second conductive portions, wherein each first conductive portion of each said generally planar conductive ground layer extends to and is exposed on a selected one of said second pair of opposing sides, and wherein each second conductive portion of each said generally planar conductive ground layer extends to and is exposed on the other one of said second pair of opposing sides.

32. The surface-mounted feedthru device of claim 31, wherein each said first conductive portion of each said generally planar conductive ground layer is characterized by a distance L1 measured along said second dimension between said second pair of opposing sides, and wherein each said second conductive portion of each said generally planar conductive ground layer is characterized by a distance L2 measured along said second dimension between said second pair of opposing sides, and wherein distance L1 is substantially equal to distance L2.

33. The surface-mounted feedthru device of claim 31, wherein each said first conductive portion of each said generally planar conductive ground layer is characterized by a distance L1 measured along said second dimension between said second pair of opposing sides, and wherein each said second conductive portion of each said generally planar conductive ground layer is characterized by a distance L2 measured along said second dimension between said second pair of opposing sides, and wherein distances L1 and L2 are different values so as to effect signal filtering at two different predetermined frequencies.

34. A multi-layer feedthru device, comprising:
a body having a width dimension generally shorter than a length dimension thereof, and having multiple alternating layers of conductive and semiconductive material;
wherein selected of said layers of conductive material comprise main signal carrying conductors that extend along said generally shorter width of said body of the multi-layer feedthru device, while selected others of said layers of conductive material comprise transient grounding electrical conductors that extend along said length of said body of the multi-layer feedthru device in a generally perpendicular fashion to the main signal carrying conductors; and
wherein said main signal carrying conductors have a relatively wide current path, such that the resulting internal equivalent series resistance of said multi-layer feedthru device is relatively decreased while the current handling capability of said multi-layer feedthru device is relatively increased.

35. The multi-layer feedthru device of claim 34, wherein each transient grounding electrical conductor comprises paired portions having respective first and second predetermined lengths.

36. The multi-layer feedthru device of claim 35, wherein said first and second predetermined lengths are substantially equal.

37. The multi-layer feedthru device of claim 35, wherein said first and second predetermined lengths are substantially not equal so as to provide dual frequency filtering at two different respective predetermined frequencies.

38. The multi-layer feedthru device of claim 34, further comprising a plurality of metallic elements, wherein at least one of said metallic elements is attached to and electrically connecting selected of said main signal carrying conductors, and wherein at least one other of said metallic elements is attached to and electrically connecting selected of said transient grounding electrical conductors.

39. The multi-layer feedthru device of claim 34, wherein said length of said multi-layer feedthru device is about twice as long as said generally shorter width of said multi-layer feedthru device.

40. The multi-layer feedthru device of claim 34, wherein said relatively wider current paths of said main signal carrying conductors respectively have dimensions which are greater than said generally shorter width of said multi-layer feedthru device.
